(19) United States
(12) Patent Application Publication
(10) Pub. No.: US 2026/0063783 A1
(43) Pub. Date: Mar. 5, 2026

(54) RADAR SYSTEM

(71) Applicant: Robert Bosch GmbH, Stuttgart (DE)

(72) Inventors: Benedikt Loesch, Stuttgart (DE); Daniel Schindler, Korntal-Münchingen (DE); Tobias Schmid, Fluorn-Winzeln (DE)

(21) Appl. No.: 19/284,777

(22) Filed: Jul. 30, 2025

(30) Foreign Application Priority Data
Aug. 28, 2024 (DE) 10 2024 208 156.6

(51) Int. Cl. G01S 13/58; G01S 7/35; G01S 13/931

(52) U.S. Cl. CPC G01S 13/584; G01S 7/356; G01S 13/931

(57) ABSTRACT

A radar system having a transmitting and receiving device which is configured to transmit a transmission signal comprising a sequence of measurement periods separated from one another by pauses. In each measurement period, at least one sequence of frequency-modulated signals is transmitted, and having a digital evaluation device which is configured to determine distances and radial relative velocities of located radar targets. The measurement periods are each divided into a plurality of non-equidistant modulation bursts.

### CROSS REFERENCE

The present application claims the benefit under 35 U.S.C. § 119 of Germany Patent Application No. DE 10 2024 208 156.6 filed on Aug. 28, 2024, which is expressly incorporated herein by reference in its entirety.

### FIELD

The present invention relates to a radar system having a transmitting and receiving device which is designed to transmit a transmission signal comprising a sequence of measurement periods separated from one another by pauses, wherein, in each measurement period, at least one sequence of frequency-modulated signals is transmitted, and having a digital evaluation device which is configured to determine distances and radial relative velocities of located radar targets.

In particular, the present invention relates to a radar system that is used in driver assistance systems of motor vehicles or in autonomous driving systems to detect the traffic environment.

### BACKGROUND INFORMATION

Conventional radar sensors of this type have a cyclic modulation pattern. Each cycle consists of a measurement period and a pause. In so-called chirp-sequence radar systems, the transmission signal is modulated in each measurement period so that it forms an equidistant sequence of frequency ramps. The signal transmitted and received again after reflection at a radar target is mixed with a portion of the signal transmitted at the time of reception, so that a baseband signal is obtained by beating, the frequency of which baseband signal is equal to the frequency difference between the transmitted signal and the received signal. Due to the ramp-shaped frequency modulation, this frequency difference is proportional to the steepness of the frequency ramps and to the propagation time of the signal from the radar sensor to the radar target and back. If a Fourier transformation is performed on the signal obtained on a frequency ramp, a spectrum is obtained in which each located object is represented in the form of a peak whose frequency position indicates the distance of the object. If the radial relative velocity of the object relative to the radar sensor is different from zero, an additional frequency shift results due to the Doppler effect, which, however, can be neglected in the distance measurement if the ramp steepness is large enough. However, the Doppler shift leads to a phase progression of the received signal from ramp to ramp, which can be used to determine the radial velocity of the object. To do this, a Fourier transformation is performed on the received signals that are received on the successive frequency ramps at the corresponding sampling times.

The resolution capacity Δd of the radar sensor in the distance dimension is better (small Δd) the steeper the frequency ramps and the correspondingly greater the bandwidth of the transmission signal. In comparison, the resolution capacity Δv in the relative velocity or Doppler dimension is better the longer the observation period, i.e. the duration of the measurement period. However, due to the periodicity of the radar signals, ambiguities arise in both distance measurement and velocity measurement if the sampling times are too far apart in time. If dₘₐₓ is the range of the radar sensor, i.e. the maximum distance from radar targets that can still be detected, then, given equidistant sampling, dₘₐₓ/Δd sampling values must be distributed over the bandwidth. If the velocity interval, within which the relative velocities of objects that are to be expected in practice lie, is limited downwardly by vₘᵢₙ (typically negative) and upwardly by vₘₐₓ, then (vₘₐₓ−vₘᵢₙ)/ Δv temporal sampling values must be distributed over the measurement duration.

For signal evaluation and object tracking, it is advantageous if the frequency ramps transmitted during the measurement period are equidistant and if the duration of the measurement cycles is also constant.

Another conventional modulation method is the OFDM method (Orthogonal Frequency Division Multiplex), which uses a plurality of orthogonal subcarriers. The temporal sampling over the measurement duration is then carried out by transmitting a plurality of so-called OFDM symbols. This method also allows distance and velocity measurements with limited resolution and corresponding unambiguousness criteria.

In order to achieve the highest possible resolution in the velocity dimension, the duration of the measurement period should be as long as possible. However, there are limits to increasing the measurement duration, because the latency time that elapses until the location results are available for a decision about necessary reactions by the driver assistance system also increases with the measurement duration. A further limitation of the measurement duration results from the thermal resilience of the radar sensor.

To improve the resolution, it is also conventinal to carry out the evaluation on the basis of signals obtained in a plurality of successive measurement cycles. In this case, however, migration effects, in particular changes in the velocity of the radar targets over the very long observation period, must generally be taken into account and compensated for in the evaluation.

### SUMMARY

An object of the present invention is to provide a radar system that enables high-resolution yet unambiguous measurements of relative velocities.

This object may be achieved according to the present invention in that the measurement periods are each divided into a plurality of non-equidistant modulation bursts.

A modulation burst is understood here as a sequence of frequency-modulated signals whose time intervals are generally smaller than the smallest time interval between successive modulation bursts. The modulation bursts are, in a sense, “packets” of signals transmitted in close succession, separated from one another by somewhat larger time gaps. The signals transmitted in close succession can be, for example, frequency ramps or OFDM symbols. While the signals within a single burst can be equidistant (and should be equidistant for reasons of signal evaluation), it is essential that the modulation bursts not be equidistant from one another, i.e. that the time intervals between the different modulation bursts vary within the measurement period. Compared to conventional radar systems, in which the successive frequency ramps have the same (smallest possible) distance, according to the invention the signal sequence is “torn apart,” so to speak, so that larger gaps occur between the individual bursts. Overall, this increases the effective observation period (the time from the first signal of the first burst to the last signal of the last burst) and thus improves the Doppler separability without increasing the total number of signals transmitted in the measurement period. This also prevents increased thermal load on the radar sensor. In addition, the varying distances between the modulation bursts break the symmetry of the Doppler spectrum, so that some of the periodically occurring peaks in the spectrum, which previously led to ambiguities, are partially suppressed. This makes it easier to resolve ambiguities.

Advantageous embodiments and developments of the present invention are disclosed herein.

To further improve the resolution capacity in the Doppler dimension, the evaluation can be carried out over a plurality of cycles, as is conventional. The non-equidistant modulation bursts then make it possible to avoid ambiguities, although the measurement periods considered in the evaluation—and thus the effective measurement times—still lie in an equidistant grid, which makes object tracking easier in later evaluation stages.

In addition, the modulation bursts can differ in their duration within a measurement period. However, from a signal processing perspective, it may be advantageous if the modulation bursts have a uniform duration.

It is also possible that a plurality of evaluations is carried out with different numbers of bursts. For example, depending on the distance range, a different number of bursts could be evaluated together. Likewise, for example, only individual bursts of the 2nd cycle can be used.

In cross-cycle evaluation, the unambiguousness can be further improved by varying the temporal arrangement of the modulation bursts from measurement cycle to measurement cycle.

The total duration of the time gaps between the modulation bursts in a measurement period represents a degree of freedom that can be used to optimize the ratio between the duration of the measurement period and the cycle time (duration of the measurement period+duration of the pause) with regard to the suppression of side lobes in the spectrum. This further facilitates the resolution of ambiguities.

The cross-cycle evaluation to determine distances and relative velocities can take place in different ways. For example, the received signals of all modulation bursts that occur in the successive measurement cycles can be evaluated together. However, migration effects due to the movement or acceleration of the radar targets must then be compensated for in a conventional manner.

According to an example embodiment of the present invention, another possibility is to first evaluate the signals in the individual measurement periods separately, so that for each measurement period, a two-dimensional spectrum (distance Doppler spectrum) is formed on the basis of the modulation bursts transmitted in this measurement period, and then to fuse the spectra obtained in the different measurement periods as part of the cross-cycle evaluation.

Another possibility is to first generate a separate two-dimensional spectrum for each individual modulation burst and then to fuse these spectra as part of a cross-burst and cross-cycle evaluation. The cross-burst and cross-cycle evaluation can also be carried out in a plurality of steps, for example by first generating the spectra for the individual bursts, these spectra can be combined to form a three-dimensional spectrum, where the third dimension represents the sequence of bursts in the measurement period, and then fusing the 3D spectra obtained for the different measurement periods.

In the following, exemplary embodiments of the present invention are explained in more detail with reference to the figures.

### BRIEF DESCRIPTION OF THE DRAWINGS

FIG. 1 is a simplified block diagram of a radar system according an example embodiment of the present invention.

FIG. 2 is a frequency/time diagram of a conventionally modulated transmission signal.

FIG. 3A shows the modulation scheme of the transmission signal according to FIG. 2.

FIG. 3B shows a modulation scheme with equidistant modulation bursts.

FIGS. 3C-3E show three examples of modulation schemes with non-equidistant modulation bursts according to the present invention.

FIG. 4 shows Doppler spectra for the modulation schemes according to FIGS. 3B and 3C;

FIG. 5 shows a Doppler spectrum for the modulation scheme according to FIG. 3A with cross-cycle evaluation over four measurement cycles.

FIG. 6 shows a Doppler spectrum for the modulation scheme according to FIG. 3B with cross-cycle evaluation over four measurement cycles.

FIG. 7 shows a Doppler spectrum for the modulation scheme according to FIG. 3B with cross-cycle evaluation over four measurement cycles.

FIG. 8 shows a Doppler spectrum for the modulation scheme according to FIG. 3C with cross-cycle evaluation over two measurement cycles.

FIG. 9 shows a Doppler spectrum for the modulation scheme according to FIG. 3C with cross-cycle evaluation over 4 measurement cycles.

FIGS. 10A-10D show four examples of different evaluation methods, according to an example embodiment of the present invention.

### DETAILED DESCRIPTION OF EXAMPLE EMBODIMENTS

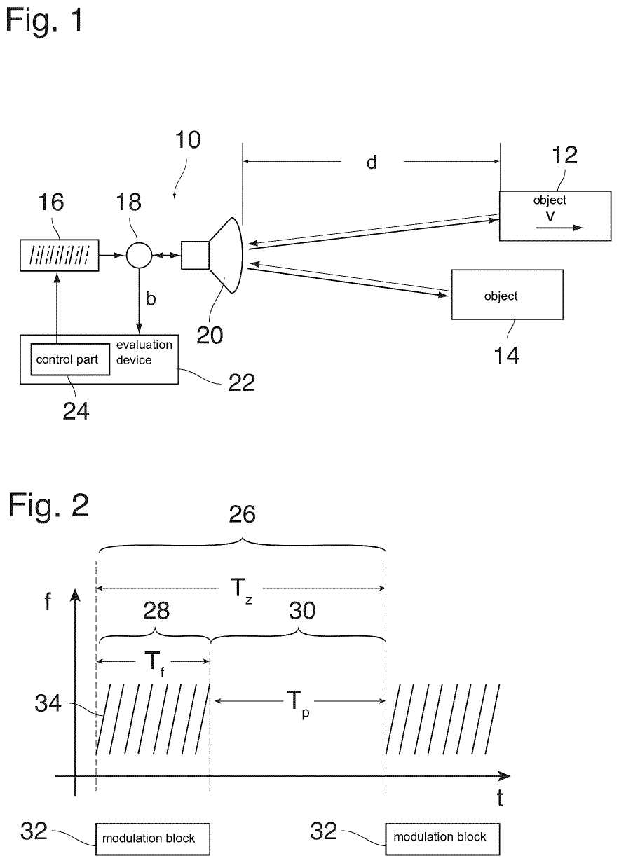

FIG. 1 shows a simplified block diagram of an FMCW radar sensor 10 which is installed, for example, in the front of a motor vehicle and is used to measure distances d and relative velocities v of objects 12, 14, for example of vehicles driving ahead. The radar sensor 10 has a voltage-controlled oscillator 16 which supplies a frequency-modulated transmission signal via a mixer 18 to a transmitting and receiving device 20, from which the signal is transmitted in the direction of the objects 12, 14. The signal reflected by the objects is received by the transmitting and receiving device 20 and mixed with a portion of the transmission signal in the mixer 18. In this way, a baseband signal b is obtained which is further evaluated in a digital evaluation device 22. The evaluation device 22 contains a control part 24 which controls the function of the oscillator 16. The frequency of the transmission signal supplied by the oscillator is modulated within a radar measurement with sequences of rising or falling ramps.

FIG. 2 illustrates a conventional modulation scheme for radar transmission signals using a diagram in which the frequency f of the transmitted signal is given as a function of time t. A single measurement cycle 26 with the duration T_{z} comprises a measurement period 28 with the duration T_{f}, followed by a pause 30 with the duration Tₚ. The pause 30 is followed by a new measurement cycle, which is identical to measurement cycle 26. The measurement periods 28 are additionally symbolized in FIG. 2 by modulation blocks 32. In each measurement period 28, a sequence of equidistant linear frequency ramps 34 is transmitted.

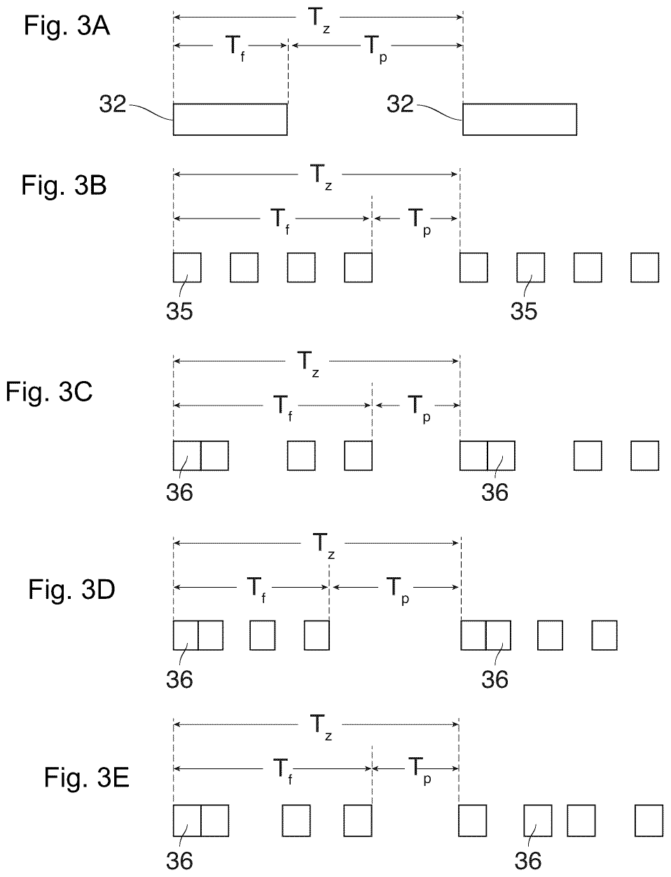

The same modulation scheme is also shown in FIG. 3A, but without the frequency/time diagram.

FIG. 3B shows a modulation scheme in which a sequence of equidistant modulation bursts 35 is transmitted in each measurement period instead of a modulation block 32. Each modulation burst 35 consists of a sequence of frequency ramps in close succession, similar to the frequency ramps 34. These frequency ramps can have the same steepness and the same mutual spacing as the frequency ramps 34 in FIG. 2, but their number is smaller because the duration of a single modulation burst 3 is shorter than the duration of the modulation block 32. In FIG. 3B, the modulation block 32 has been divided into four separate modulation bursts 34 which follow one another at a time interval. This increases the duration T_{f} of the measurement period at the expense of the duration Tₚ of the pause, while the duration T_{z} of the cycle remains unchanged. In another embodiment, Tₚ can also be reduced to zero.

FIGS. 3C-3E show exemplary embodiments of the invention in which non-equidistant modulation bursts (36) are used.

In FIG. 3C, the duration T_{f} of the measurement period and the duration Tₚ of the pause is the same as in FIG. 3B, and the pattern of these distances between the modulation bursts 36 is the same in each measurement cycle.

FIG. 3D shows an example in which the time gaps between the modulation bursts 36 are smaller than in FIG. 3C. The duration T_{f} of the measurement period has therefore decreased compared to FIG. 3C, but is still larger than in FIG. 3A. The change in the distances between the modulation bursts 36 also changes the shape of the Doppler spectrum formed from the received signals. The variation of the duration T_{f} of the measurement period (without changing the duration of the modulation bursts (36)) can therefore be used to modify the obtained spectrum in such a way that side lobes are suppressed as much as possible, and therefore ambiguities can be resolved more easily. The suppression of side lobes can also be a criterion if the bursts are not arranged equidistantly within the measurement period.

FIG. 3E shows an example where the duration T_{f} of the measurement period and the duration T_{z} of the entire cycle are the same as in FIG. 3C, but in the second measurement cycle the time intervals separating the individual modulation bursts 36 are different from those in the first measurement cycle. Varying these distances from cycle to cycle can also contribute to improving the resolution of ambiguities.

The measurement data contained in a single measurement cycle can be evaluated by performing a two-dimensional digital Fourier transformation, for example a fast Fourier transform (FFT), on the baseband signal b. By performing the Fourier transformation over sampling points within a single frequency ramp, a distance spectrum is obtained. Each located radar target appears in this spectrum as a peak whose frequency position depends on the distance of the object. The Fourier transformation over sampling times that lie in the successive ramps of a modulation burst produces a Doppler spectrum that indicates the complex amplitude of the received signal as a function of the Doppler frequency. Since this Doppler frequency is proportional to the relative velocity of the object, the different points on the frequency axis of this spectrum represent hypotheses about the relative velocity v of the object. The received radiation power is greater the more the velocity hypothesis agrees with the true velocity of the object. For example, if a radar echo is received from a target that has a relative velocity v=0, a peak will appear in the spectrum at the value v=0. This peak is sharper the longer the observation period (T_{f}) is. For example, the modulation pattern shown in FIG. 3A with T_{f}=20 ms and Tₚ=30 ms results in a peak width and thus a relative velocity resolution of 0.098 m/s. However, if the observation period T_{f} is 35 ms and Tₚ is thus only 15 ms with the same cycle time, as in FIGS. 3B and 3C, an improved relative velocity resolution of about 0.056 m/s results. This resolution also determines the size of the Doppler bins in the two-dimensional spectrum.

However, due to the periodicity of the signals, the spectrum for a single radar target does not have a single peak, but rather a regular sequence of peaks at different Doppler frequencies, and each of the corresponding velocities could be the true velocity of the target. The velocity measurement is therefore ambiguous. The distances between the peaks are greater the smaller the time intervals are between the successive frequency ramps 34 within a modulation block or burst. However, in the case of a plurality of modulation bursts 36 per measurement cycle, they also depend on the temporal sequence of the bursts.

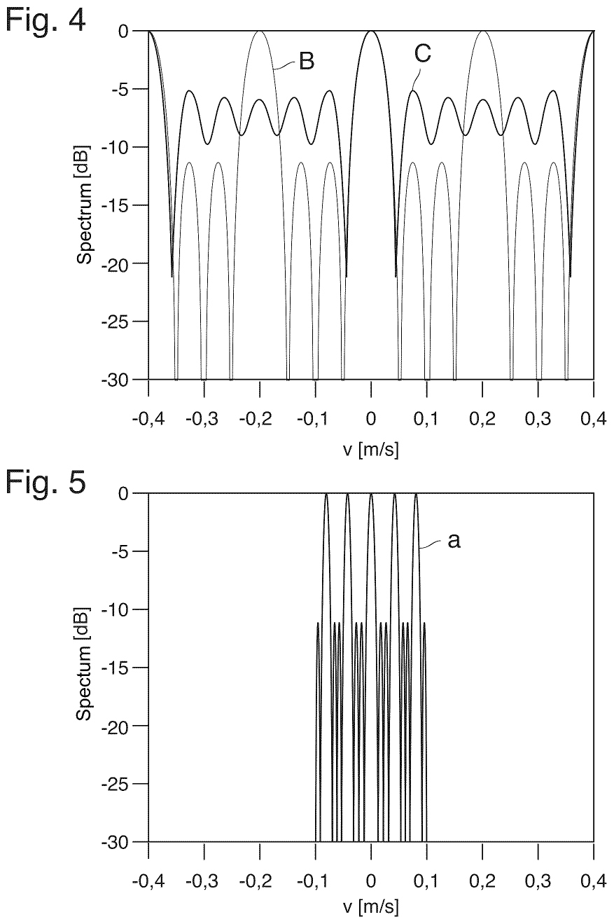

FIG. 4 shows the Doppler spectra for the modulation patterns shown in FIGS. 3B and 3C, assuming in each case that a single target is located which has zero relative velocity. Curve B, shown in thinner lines, corresponds to the modulation pattern shown in FIG. 3B with four modulation bursts, each 5 ms in length, and equidistant start times of 0, 10, 20 and 30 ms, respectively. You can see that the distance from peak to peak is about 0.2 m/s. Curve C, shown in bold lines, is the spectrum for the modulation pattern shown in FIG. 3C, where the modulation bursts of 5 ms in length have non-equidistant start times of 0 ms, 5 ms, 20 ms and 30 ms. This sequence of modulation bursts increases the peak-to-peak distance by 0.4 m/s, i.e., the velocity range within which an unambiguous measurement is possible has been doubled. At the same time, this sequence of modulation bursts reduces the mutual influence of two radar targets within a Doppler bin.

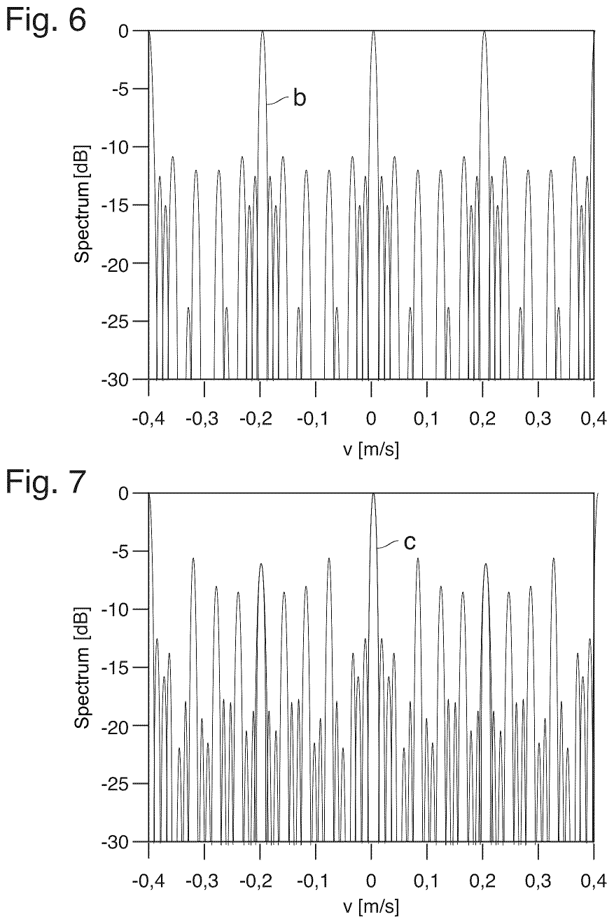

In the following, Doppler spectra for different modulation patterns are to be compared, which spectra are obtained when the evaluation is carried out over a plurality of measurement cycles, in this example over four measurement cycles. Curve a in FIG. 5 shows the spectrum for the modulation pattern according to FIG. 3A, curve b in FIG. 6 shows the spectrum for the modulation pattern according to FIG. 3B, and curve c in FIG. 7 shows the spectrum for the modulation pattern according to FIG. 3C. It can be seen that in the standard modulation method with only a single modulation block 32 per cycle (FIG. 5), ambiguities occur at intervals of only 0.04 ms. In the case of equidistant modulation bursts as shown in FIG. 6, ambiguities occur at significantly larger intervals of 0.2 m/s, and in the case of modulation without equidistant bursts (FIG. 7), the distance between the ambiguities is doubled again to 0.4 m/s.

Various methods are available with which these ambiguities can be resolved, so that an unambiguous determination of the relative velocity in a larger velocity interval becomes possible. Examples of such methods are described in Germany Patent Application Nos. DE 10 2014 212 280 A1, DE 10 2014 212 284 A1, and DE 10 2017 200 317 A1, and U.S. Patent Nos. US 10,921,436 B2, 11,614,531 B2 and US 11,774,552 B2. In general, however, ambiguity resolution is only possible if no ambiguities occur within a range of ±0.5 Doppler bins. In the examples described here, this can only be achieved with the modulation pattern shown in FIG. 3C. Furthermore, FIG. 7 shows that, when modulating with non-equidistant bursts, the side lobes (targets with different relative velocities) can be suppressed by more than 5 dB.

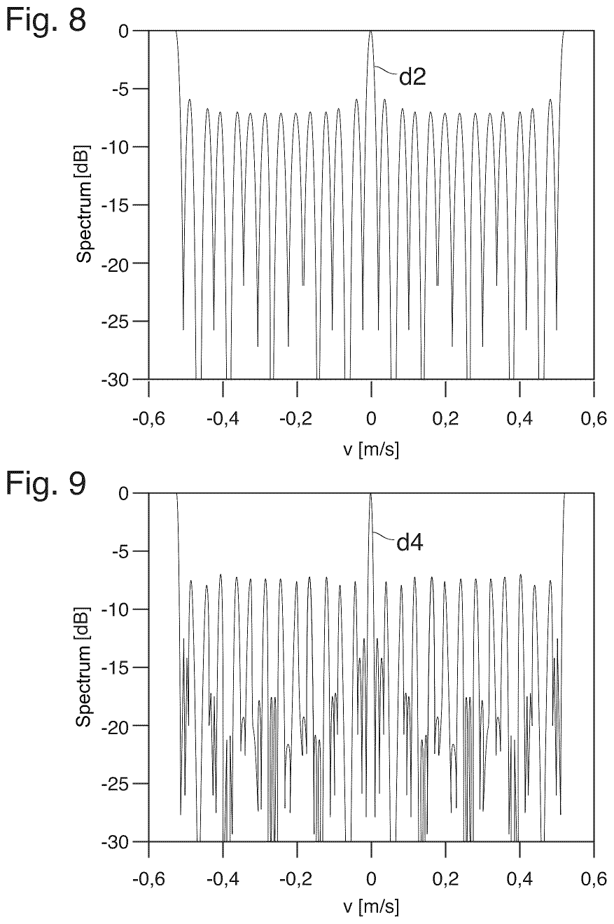

FIGS. 8 and 9 show spectra for the modulation pattern according to FIG. 3D, in which the duration of the modulation bursts was shortened to 3.8 ms to further suppress the side lobes in the spectrum, and non-equidistant start times of 0 ms, 3.8 ms, 15.2 ms and 22.8 ms were used. The cycle time T_{z} is 50 ms, as with the other patterns. The curve d2 in FIG. 8 relates to the case where the evaluation was carried out over two measurement cycles, while the curve d4 in FIG. 9 relates to the case where the evaluation was carried out over four measurement cycles. In FIG. 9, it can be seen that it was possible to suppress the side lobes by significantly more than 5 dB.

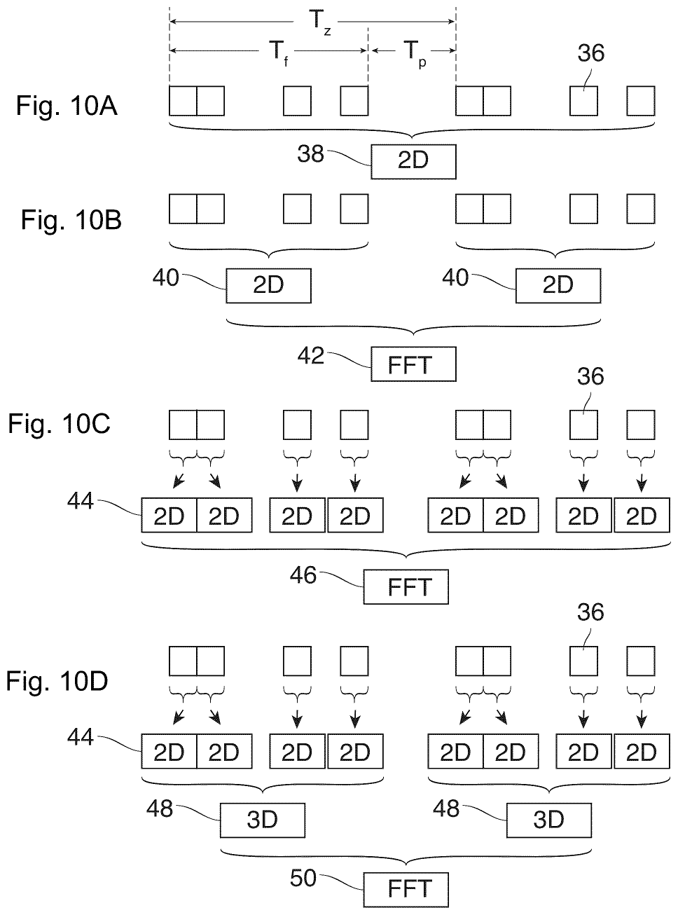

Different evaluation strategies are shown schematically in FIGS. 10A-10D. In FIG. 10A, the modulation bursts 36 of a plurality of successive measurement cycles are evaluated together (across bursts and cycles), if necessary with compensation for migration effects. For example, if the evaluation is carried out over four measurement cycles, a common two-dimensional spectrum 38 (with the dimensions “distance” and “velocity”) is obtained for all four measurement cycles.

In FIG. 10B, a separate evaluation is first carried out for each individual measurement cycle, so that a separate two-dimensional spectrum 40 is obtained for each measurement cycle. The cross-cycle evaluation then consists of a third fast Fourier transform (FFT) 42 across the cycles. The 2D spectra 40 obtained for the individual cycles can already be used for object detection.

In FIG. 10C, in a first step, a 2D spectrum 44 is formed for each individual modulation burst 36, and then a third FFT 46 is performed over the modulation bursts of the plurality of measurement cycles.

In FIG. 10D, the first evaluation step is the same as in FIG. 10C. In the next step, however, a third FFT is performed only for the spectra of a single cycle, so that a three-dimensional spectrum with the dimensions “distance”, “velocity” and “burst” is obtained for each cycle. The cross-cycle evaluation then consists of a fourth FFT 50 across the cycles.

Compensation for migration effects can optionally be performed before the third FFT 42 or 46 or before the fourth FFT 50.

In the cross-cycle evaluation, a multi-target model with improved frequency separation capability can be used to model the signals in the various variants instead of a single-target model.

While in the methods described here, the frequency ramps 34 have the same slope, the same spacing, and the same center frequency within the individual modulation bursts, variants are also possible in which these parameters vary within a burst or from burst to burst. For example, the modulation burst can consist of a sequence of frequency ramps with a linearly increasing or decreasing center frequency.

In addition, the modulation parameters can also be varied from measurement cycle to measurement cycle. The variation of the parameters then has to be taken into account in an appropriate manner during the evaluation.

What is claimed is:

1. A radar system, comprising:
a transmitting and receiving device configured to transmit a transmission signal including a sequence of measurement periods which are separated from one another by pauses, wherein, in each measurement period, at least one sequence of frequency-modulated signals is transmitted; and
a digital evaluation device configured to determine distances and radial relative velocities of located radar targets;
wherein the measurement periods are each divided into a plurality of non-equidistant modulation bursts.

2. The radar system according to claim 1, wherein an evaluation for determining the relative velocities takes place over a plurality of measurement cycles.

3. The radar system according to claim 2, wherein the evaluation device is configured to calculate a two-dimensional spectrum which is based on the measurement signals for the modulation bursts in the plurality of measurement cycles.

4. The radar system according to claim 2, wherein the evaluation device is configured to first calculate two-dimensional spectra for each individual measurement cycle and then to evaluate the spectra across cycles in a second step.

5. The radar system according to claim 2, wherein the evaluation device is configured to first calculate a two-dimensional spectrum for each individual modulation burst in the plurality of measurement cycles and then to evaluate the spectra across bursts and cycles.

6. The radar system according to claim 2, wherein the evaluation device is configured to first calculate two-dimensional spectra for each individual modulation burst in the plurality of measurement cycles, and then to calculate a three-dimensional spectrum from the spectra obtained for each individual measurement cycle, and then to evaluate, across cycles, the three-dimensional spectra obtained for the plurality of measurement cycle.

7. The radar system according to claim 1, wherein the modulation bursts have a uniform duration within a measurement period.

8. The radar system according to claim 1, wherein a temporal arrangement of the modulation bursts varies from measurement cycle to measurement cycle.

9. The radar system according to claim 1, wherein a Doppler spectrum is calculated to determine the relative velocities, and wherein a ratio between a duration of the measurement period and a duration of an entire measurement cycle is selected such that maximum suppression of side lobes in a Doppler spectrum is achieved.
